(19) United States
(12) Patent Application Publication
(10) Pub. No.: US 2023/0041896 A1
(43) Pub. Date: Feb. 9, 2023

(54) OPTICAL-ELECTRO SYSTEM

(71) Applicant: SUTENG INNOVATION TECHNOLOGY CO., LTD., Shenzhen (CN)

(72) Inventors: Yalin REN, Shenzhen (CN); Letian LIU, Shenzhen (CN)

(73) Assignee: SUTENG INNOVATION TECHNOLOGY CO., LTD., Shenzhen (CN)

(21) Appl. No.: 17/971,551

(22) Filed: Oct. 21, 2022

Related U.S. Application Data
(63) Continuation of application No. PCT/CN2020/086230, filed on Apr. 22, 2020.

(51) Int. Cl. G01S 7/4912; G01S 17/89; G01S 17/34; G01S 17/58

(52) U.S. Cl. CPC G01S 7/4917; G01S 17/89; G01S 17/34; G01S 17/58

(57) ABSTRACT

The present application relates to an optical-electro system, which includes a substrate; at least one photo-detecting unit at least partially formed on the substrate to detect a signal light; at least one optical waveguide at least partially formed on the substrate, each of the at least one optical waveguide connected to one of the at least one photo-detecting unit to input a local light; and at least one electronic output port connected to the at least one photo-detecting unit to transmit at least one electronic output signal from the at least one photo-detecting unit, wherein the at least one electronic output signal is associated with the signal light and the local light.

### CROSS-REFERENCE TO RELATED APPLICATION

The present application is a continuation of International Application No. PCT/CN2020/086230, filed on Apr. 22, 2020, the content of which is incorporated herein by reference in its entirety.

### TECHNICAL FIELD

This application relates to Lidar technology. Specifically, this application relates to coherent Flash Lidar.

### BACKGROUND

Lidar is an acronym of light detection and ranging. It is a surveying method that measures distance to a target by illuminating the target with laser light and measuring the differences of returning times and wavelengths between the laser light and the reflected signal light. Lidars are currently widely used to make 3-D images of an object.

Currently, a majority of Lidars use Time of Flight (TOF) technology, which is a method to use laser pulses at fixed wavelength to measure the distance between the Lidar and the target, based on the time difference At between the emission of the laser and its return to the Lidar. To this end, the Lidar needs to scan one or more laser beams over its field of view, where the target locates. This technology requires a rotation part in order for the laser beams to scan through the field of view. Because of the existence of the rotation part and the reason that 3-D image is measured point by point, the speed of acquiring the 3-D image is slow.

Alternatively, the Lidar may use a single light source that illuminates the field of view in a single pulse, just like a camera that takes pictures of distance, instead of colors. This type of Lidar is called Flash Lidar. The TOF Flash Lidar, however, is susceptible to noise because of the weakness of the returned pulses and wide bandwidth of the detection electronics, and threshold triggering can produce errors in measurement of Δt. Therefore, the TOF Flash Lidar cannot achieve long-distance signal detection.

Therefore, in order to solve the above technical problem, there is a need to design a solid-state Flash Lidar that is capable of conducting long-distance signal detection and is immune from noise at the same time.

### SUMMARY

To solve the technical problem addressed above, the present application provides an optical-electro system that integrates a plurality of photodetectors on a chip. Using Frequency Modulated Continuous Wave (FMCW) technology, by inputting a reflected signal light and a local light coherent with the signal light into the chip, the optical-electro system may conduct long-distance signal detection with little noise.

According to an aspect of the present application, the optical-electro system may include a substrate; at least one photo-detecting unit at least partially formed on the substrate to detect a signal light; at least one optical waveguide at least partially formed on the substrate, each of the at least one optical waveguide connected to one of the at least one photo-detecting unit to input a local light; and at least one electronic output port connected to the at least one photo-detecting unit to transmit at least one electronic output signal from the at least one photo-detecting unit, wherein the at least one electronic output signal is associated with the signal light and the local light.

According to some embodiments, each of the at least one photo-detecting unit is manufactured through at least one of an optoelectronic technology (e.g., Indium Phosphide, InGaAs etc.) or an integrated circuit technology.

According to some embodiments, each of the at least one photo-detecting unit includes at least one balanced photodetector.

According to some embodiments, the at least one balanced photodetector includes: a first optical input interface, formed on the substrate and connected to the optical waveguide to receive the local light from the optical waveguide; a second optical input interface, formed on the substrate to receive the signal light; an optical coupling unit formed on the substrate, connected to the first optical input interface and the second optical input interface, wherein the optical coupling unit couples the local light and the signal light to generate a first interfered light and a second interfered light; a first optical output interface connected to the optical coupling unit to output the first interfered light; and a second optical output interface connected to the optical coupling unit to output the second interfered light.

According to some embodiments, the at least one balanced photodetector further includes: a first photodetector to receive the first interfered light and convert the first interfered light into a first current; a second photodetector to receive the second interfered light and convert the second interfered light to a second current; and a current combiner, connected to: the first photodetector to receive the first current, the second photodetector to receive the second current, one of the at least one electronic output port, wherein the current combiner combines the first current and the second current to form the at least one electronic output signal.

According to some embodiments, the current combiner includes at least one amplifier.

According to some embodiments, the second optical input interface includes at least one micro-optical lens to focus the signal light to the optical coupling unit.

According to some embodiments, the local light is coherent with the signal light.

According to some embodiments, the local light includes a modulated light wave.

According to some embodiments, the modulated light wave is a frequency modulated continuous wave.

According to some embodiments, the modulated light wave is at least one of an amplitude modulated continuous wave or a phase modulated continuous wave.

According to some embodiments, each of the at least one optical waveguide is configured to compensate the local light with a phase difference with respect to a reference phase.

According to some embodiments, the at least one optical waveguide includes a phase shifting unit to compensate the local light with the phase difference with respect to the reference phase.

According to some embodiments, the at least one optical waveguide compensates the local light with the phase difference through optical path length compensation.

According to some embodiments, the at least one optical waveguide is configured to compensate the local light with the phase difference through refractive index compensation.

According to some embodiments, the optical-electro system further includes a light source to emit a source light.

According to some embodiments, the optical-electro system further includes a beam splitter to receive the source light and split the source light into an emitted signal light and the local light.

According to some embodiments, the signal light is the emitted signal light reflected from a target object.

According to some embodiments, the optical-electro system further includes a light emission port to emit the emitted signal light.

According to some embodiments, the light emission port includes a diffuser to receive the emitted light beam and diffuse the emitted light beam towards a target object.

### BRIEF DESCRIPTION OF DRAWINGS

The present disclosure is further described in terms of exemplary embodiments. The foregoing and other aspects of the embodiments of the present disclosure are made more evident in the following detailed description, when read in conjunction with the attached figures.

FIG. 1A illustrates an optical detecting system according to embodiments of the present application;

FIG. 1B shows a sawtooth frequency modulated signal according to embodiments of the present application;

FIG. 2A illustrates a structure of the photodetector assembly according to embodiments of the present application;

FIG. 2B shows the structure of a slab optical waveguide formed on a substrate according to embodiments of the present application;

FIG. 2C illustrates a diagram of a balanced photodetector unit according to embodiments of the present application; and

FIG. 2D illustrates a diagram of a light receiving aperture according to embodiments of the present application.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprises,” “comprising,” “includes,” and/or “including” when used in this specification, specify the presence of stated features, integers, steps, operations, elements, and/or components, but do not preclude the presence or addition of one or more other features, integers, steps, operations, elements, components, and/or groups thereof. Terms that express relative positions between two elements, such as “in,” “on,” “above,” “below,” and “contact” may be construed as directly or indirectly in that relative position. For example, the term “A contacts B” may be construed as A directly contacts B or A indirectly contacts B.

These and other features, and characteristics of the present disclosure, as well as the methods of operation and functions of the related elements of structure and the combination of parts and economies of manufacture, may become more apparent upon consideration of the following description with reference to the accompanying drawing(s), all of which form a part of this specification. It is to be expressly understood, however, that the drawing(s) are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may or may not be implemented in order. Conversely, the operations may be implemented in inverted order, or simultaneously. Moreover, one or more other operations may be added to the flowcharts. One or more operations may be removed from the flowcharts.

Moreover, while the system and method in the present disclosure is described primarily in regard to unmanned moving platforms, it should also be understood that this is only one exemplary embodiment. The system or method of the present disclosure may be applied to any other kind of moving platforms.

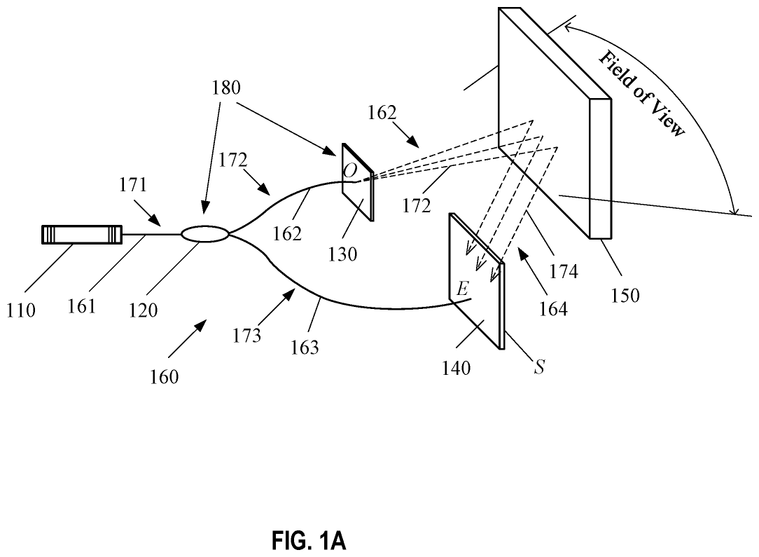

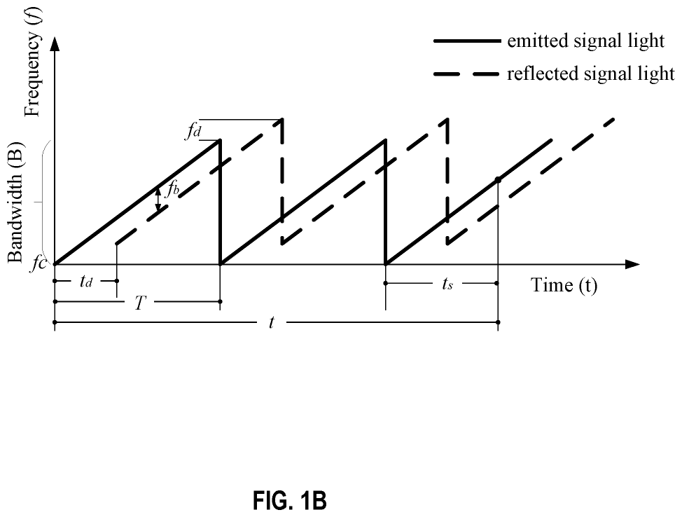

FIG. 1A illustrates a photo-detecting system 100 according to embodiments of the present application. The photo-detecting system (hereinafter “the system”) 100 may include a light source 110, a light divider 180, and a photodetector assembly 140. The above components of the system 100 may be arranged and/or connected in a light path 160.

The light path 160 may be a path that a light in the system 100 passes through. In FIG. 1A, the light path 160 may be divided in several sections made by different materials. For example, the light path 160 may include a first light path 161, a second light path 162, a third light path 163, and a fourth light path 164. Details of these light paths will be described elsewhere in the present application.

The first light path 161 may be a waveguide that connects the light source 110. The first light path 161 may be air, or may be solid state waveguide, such as optical fiber or waveguide formed on an optical chip.

The light source 110 may be a light generator to emit a first light, or source light 171, which passes through the first light path section 161. The source light 171 may be a continuous wave. For example, the light source 110 may be a continuous-wave generator, such as a laser generator; accordingly, the source light 171 may be a continuous wave, such as a laser beam. Moreover, the light source 110 may be a light generator to emit a modulated continuous wave. Accordingly, the source light 171 may be a modulated light. For example, the source light 171 may be frequency modulated (i.e., frequency modulated continuous wave—FMCW), amplitude modulated (i.e., amplitude modulated continuous wave—AMCW), phase modulated (i.e., phase modulated continuous wave—PMCW), or a light being modulated with any combination thereof. Simply for illustration purpose, the application takes a laser generator as an example of the light source 110, and takes a FMCW laser beam as an example of the source light 171. Further, the laser beam 110 may be of various frequency modulations, such as sawtooth frequency modulation, triangle frequency modulation, sinusoidal frequency modulation, or any combination thereof. The present application takes sawtooth frequency modulation as an example of the source light 171 to illustrate the invention. Assuming that the sawtooth FMCW has a form as shown in FIG. 1B, where the starting frequency of the source light 171 is f_{c}, the sweeping bandwidth of the frequency is B, and the period of the frequency sweep is T, the source light 171 may be expressed as:

$${E}_{0} = {P}_{0} exp \{ - j [ 2 π [ {f}_{c} ( nT + {t}_{s} ) + \frac{α {t}_{s}^{2}}{2} ] + {φ}_{0} ] \}$$

where E₀ represents the source light 171, P₀ is the amplitude of the source light 171, tₛ is a time from the start of n^{th} sweep and 0<tₛ<T, a=B/T which is the slope of the sawtooth function, and φ₀ is the initial phase of the signal.

Although the present application takes sawtooth FMCW laser beam as an example to illustrate the invention, one of ordinary skill in the art would understand at the time of filing this application that other form of modulation to the laser beam 110 and other shape of modulation may also be adopted by the application without departing from the spirit of the invention.

The source light 171 may pass through the first light path 161 and may be inputted into the light divider 180. The light divider 180 may be of any forms as long as it serves the purpose of sending a portion of the source light 171 to the third light path 163 as well as generating a light field that illuminates the whole Field of View (FOV), as shown in FIG. 1A, where a target object 150 is located. The light divider 180 may be part of the light source 110, or may be an optical unit independent from the light source 110.

For example, the light divider 180 may include a first beam divider 120, which may be connected to the other end of the first light path 161. The first beam divider 120 may be an optical unit to spread the source light 171. When the source light 171 passes through the first beam divider 120, it may be divided into two or more separate beams by the first beam divider 120. For example, the first beam divider 120 may be a diffractive optical unit, such as a first beam splitter. Here, the first beam splitter may be a 1×k optical coupler to divide an input beam into k output beams, where k is an integer greater than 1. The first beam divider 120 may also be a grating or other type of optical unit, such as a half-silvered mirror, to divide the source light 171.

The first beam divider 120 may be positioned and/or located in the light path 160. For example, the first beam divider 120 may connect to the other end of the first light path 161 as an input light path. As shown in FIG. 1A, after receiving the source light 171 as an optical input, the first beam divider 120 may divide the source light 171 into two separate beams — a second light 172 and a third light 173. Alternatively, the first beam divider 120 may divide the source light 171 into a plurality of light beams. At least one light beam of the plurality of light beams may form the third light 173 and may be outputted to the third light path 163, and the remainder light beam of the plurality of light beams may form the second light 172 and may be outputted into the second light path 162.

In some embodiments, the second light 172 may be emitted to the target object 150, thereby may be called emitted signal light; and the third light 173 may be used as reference light or local light, serving as a reference in analyzing information of the target object carried with the second light 172 when it is reflected back from the target object 150. The reflected second light 172 may be called reflected signal light 174. Because the third light 173 and the second light 172 are split, divided, and/or derived from the same coherent source light 171, which may be a continuous wave and/or a FMCW laser, the source light 171, the second light 172, and the third light 173 are coherent.

Taking a sawtooth FMCW laser shown in FIG. 1A as an example, at this stage, the second light 172 may be expressed as:

$${E}_{S} = {P}_{S} exp \{ - j [ 2 π [ {f}_{c} ( nT + {t}_{s} ) + \frac{α {t}_{s}^{2}}{2} ] + {φ}_{0} ] \}$$

where P_{S} is the power amplitude of the second light 172, and the third light 173 may be expressed as:

$${E}_{L} = {P}_{L} exp \{ - j [ 2 π [ {f}_{c} ( nT + {t}_{s} ) + \frac{α {t}_{s}^{2}}{2} ] + {φ}_{0} ] \}$$

where P_{L} is the power amplitude of the third light 173.

After being outputted/emitted from the first beam divider 120, the third light 173 may be directed to the photodetector assembly 140 through the third light path 163; and the second light 172 may be directed into the second light path 162. The third light path 163 may connect to the first beam divider 120 at one end and connect to the photodetector assembly 140 at the other end. The third light path 163 may be air, or may be solid state waveguide, such as optical fiber or slab waveguide formed on a chip, or any combination of the air and the solid-state waveguide.

The second light path 162 may connect to the first beam divider 120 at one end. The second light path 162 may be a waveguide that connect to the first beam divider 120. The second light path 162 may be air, or may be solid state waveguide, such as optical fiber or slab waveguide formed on a chip, or any combination of the air and the solid-state waveguide.

Further, the second light path 162 may direct the second light 172 towards the target object 150. For example, when the first beam divider 120 splits and/or divides the source light 171 into a plurality of beams, the second light 172 accordingly includes a plurality or a cluster of laser beams. The plurality or cluster of laser beams included in the second light 172 may travel through the second light path 162. The second light path 162 may directly send the second light 172 toward the target object 150, or through a projector (not shown) in the second light path 162. For example, a lens assembly may be positioned in the second light path 162 (or the second light path 162 may be connected to the lens assembly if the second light path is a solid waveguide) to modify the shape of the cluster of the light beams included in the second light 172 and project the second light 172 towards the target object 150.

In the event that the first beam divider 120 splits and/or divides the source light 171 into two light beams only, which are the second light 172 and the third light 173, the light divider 180 may further include a second beam divider 130 located in the second light path 162. The second beam divider 130 may be a diffractive optical unit, such as one or more diffusers to diffuse the second light 172. The second beam divider 130 may also be one or more beam splitters and/or one or more diverging lenses, to spread out or diverge a parallel beam of light passing through it. After the second light 172 is diffused, diverged and/or spread, the second light 172 may be emitted towards the target object 150 in the field of view along the second light path 162.

Consequently, the second light 172 may become either a diverging laser beam or a cluster of laser beams or remain as a parallel laser beam. The second light 172 may then be incident to the surface of the target object and reflected back to the photodetector assembly 140 as reflected signal light 174, along with the fourth light path 164.

In FIG. 1A, the second beam divider 130, such as a diffuser or a projector, may be located at point O in the second light path 162, or in other words, point O may be the light emission port of the second light 172. The second light path 162 between point O and the target object 150 may be air. Accordingly, assuming that the photodetector assembly 140 is very close to the emitting point O, and the target object locates at an initial distance R from the emitting point O and is moving with a relative velocity of v, then the reflected signal light 174 may be expressed as:

$${E}_{S} = {P}_{S} exp \{ j [ 2 π [ {f}_{c} ( nT + {t}_{s} - τ ) + \frac{{α ( {t}_{s} - τ )}^{2}}{2} ] + {φ}_{0} ] \}$$

where τ=2(R+vt)/c=2[R+v(nT+tₛ)]/c is the delay between the emitting time of the emitted signal light 172 and the receipt time of the reflected signal light 174 by the photodetector assembly 140.

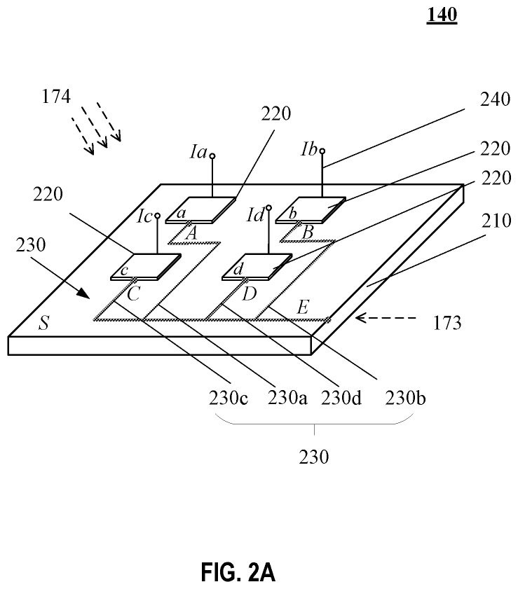

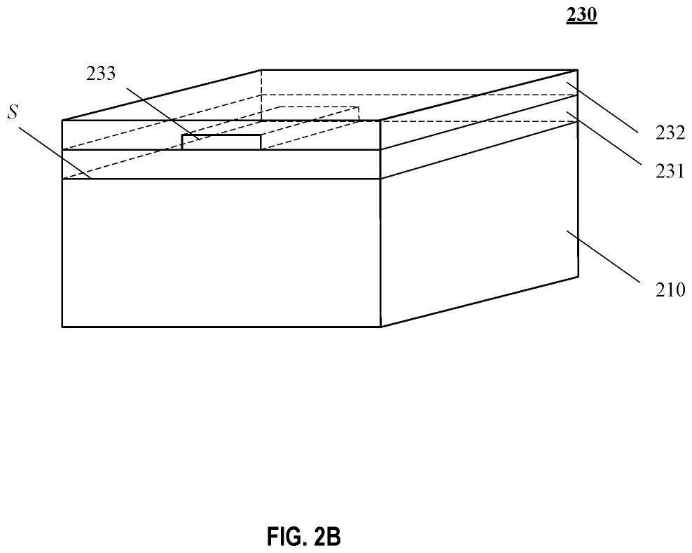

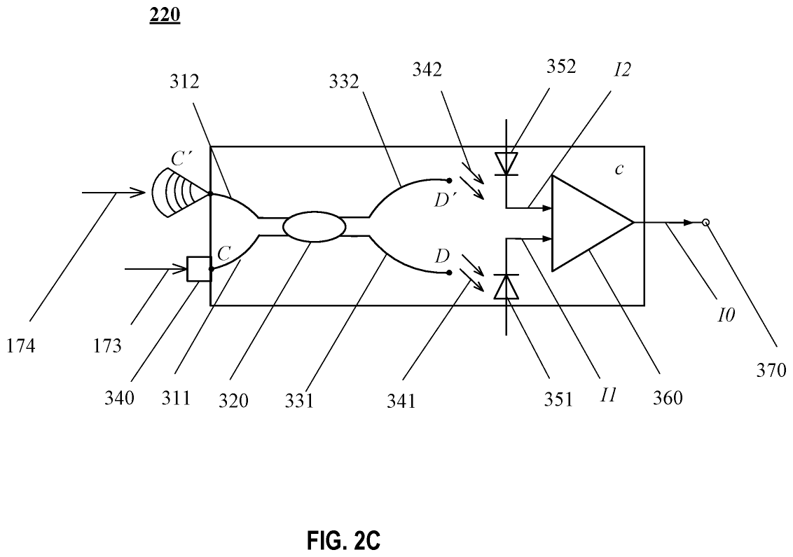

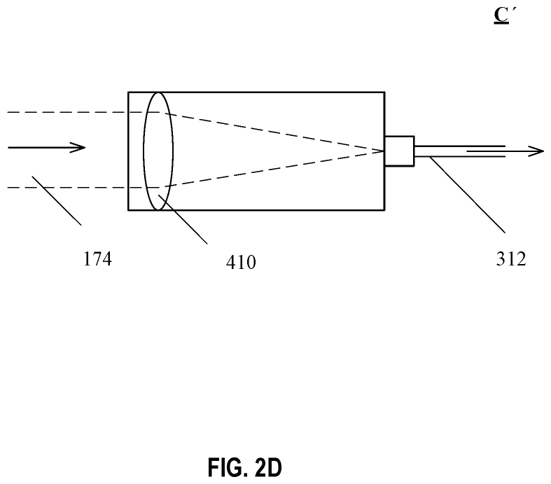

FIG. 2A illustrates a structure of the photodetector assembly 140 according to embodiments of the present application. The photodetector assembly 140 may be an optical-electro sensor to receive the reflected signal light 174 at a receiving surface S. the photodetector assembly 140 may include a substrate 210, an optical input port E, a plurality of photo-detecting units 220, a plurality of optical waveguides 230, and a plurality of electronic output port 240.

The substrate 210 may be a wafer. The wafer may be made of semiconductor material, such as a piece of single crystal silicon. Alternatively, the wafer may also be made of other type of materials, such as glass and/or polymer, etc. Further, the substrate 210 may include a receiving surface S to receive the reflected signal light 174. According to some embodiments, the receiving surface S may be a bare surface of the wafer or a layer of other material(s) deposited on the wafer. For example, the receiving surface S may be a layer of SiO₂, a layer of polysilicon or other suitable materials.

The optical input port E may be formed on the receiving surface S and configured to receive the local light 173. To this end, the optical input port E may be configured to connect to the third light path 163 with the plurality of waveguides 230. For example, if the third light path 163 is an optical fiber, then the optical input port E may be an optical coupler to couple the third light path 163 and the plurality of waveguides 230 together.

The plurality of optical waveguides 230 may be located on the receiving surface S, connecting the optical input port E with each of the plurality of photodetector units 220. For example, the plurality of waveguides 230 may be completely formed or partially formed on the receiving surface S. Alternatively, the plurality of waveguides 230 may be independent elements directly or indirectly mounted on the receiving surface S. The plurality of waveguides 230 may be of any form, such as slab waveguides, optical fibers, etc., that can guide the local light 173.

FIG. 2B shows the structure of a slab optical waveguide 230 that is formed on the receiving surface. The waveguide 230 may include a first cladding layer 231 formed on the receiving surface S, a second cladding layer 232 formed on the first cladding layer 231, and a core layer 233 formed between the first cladding layer 231 and the second cladding layer 232. By properly selecting the refraction index of the first cladding layer 231, the second cladding layer 232 and the core layer 233, the local light 173 incident into the core layer 233 may have perfect reflection in the interface between the core layer 233 and the first cladding layer 231 as well as the interface between the core layer 233 and the second cladding layer 232. Thereby the local light 173 may travel along the core layer. On the other hand, by carefully selecting the refractive index of the core layer, the optical length of the waveguide may be controlled.

The plurality of photo-detecting units 220 may be formed on the receiving surface S to receive and detect the reflected signal light 174. In some embodiments, the plurality of photo-detecting units 220 may be arranged as a M×N array, where M and N are integers greater than 1. FIG. 2A illustrates a 2×2 array photo-detecting units 220, marked as a, b, c, and d. However, one of ordinary skill in the art would understand that the M×N array may be of any size. Further, the plurality of photo-detecting units 220 may be manufactured in millimeter, micrometer, or nanometer scale, using optoelectronic technologies (e.g., Indium Phosphide, InGaAs, etc.) and/or integrated circuit technologies (e.g., CMOS processes), so that each of the plurality of photo-detecting units 220 may be a pixel-sized detector on the substrate, i.e., the size of each of the photo-detecting units is at pixel level. A typical dimension of a pixel is from sub-micrometers to tens of micrometers. Accordingly, the size of each of the photo-detecting units may be any of the following sizes or anywhere between two of the following sizes: 0.1 μm, 0.2 μm, 0.3 μm, 0.4 μm, 0.5 μm, 0.6 μm, 0.7 μm, 0.8 μm, 0.9 μm, 1 μm, 2 μm, 3 μm, 4 μm, 5 μm, 6 μm, 7 μm, 8 μm, 9 μm, 10 μm, 20 μm, 30 μm, 40 μm, and 50 μn. Accordingly, even a single pulse of the emitted signal light 172 may be enough to collect target object information in the entire field of view.

Each of the photo-detecting units 220 in the M×N array may be configured to extract the information about the target object 150, such as information about a distance and speed of the target object with respect to the system 100. To this end, each of the plurality of photo-detecting units 220 may be configured to receive the reflected signal light 174 and the local light 173, where the reflected signal light 174 and the local light 173 are coherent light. Purely for illustration purpose, in the present application, each of the photo-detecting units 220 may include a balanced photodetector to extract the relative speed and distance of the target object.

FIG. 2C illustrate a diagram of a balanced photodetector unit 220 receiving the coherent reflected signal light 174 and local light 172. The balanced photodetector unit 220 may be applied to the photo-detecting unit c as shown in FIG. 2A. Obviously, the balanced photodetector unit 220 may also be other units in FIG. 2A, such as unit a, unit b, and unit d. The balanced photodetector unit c may include an optical input interface C, a first optical output interface D, a second optical output interface D′, an optical coupling unit, and a photo-electronic unit.

The optical coupling unit may include a first input optical waveguide 311, a second input optical waveguide 312, an optical coupler 320, a first output optical waveguide 331, and a second output optical waveguide 332. The photo-electronic unit may include a first photodetector 351, a second photodetector 352, a current combiner 360, and an output port 370.

The first input optical waveguide 311 and the second input optical waveguide 312 are two input optical waveguides; the first output optical waveguide 331 and the second output optical waveguides 332 are two output optical waveguides. The four waveguides 311, 312, 331, 332 may be solid state optical waveguides, formed on the receiving surface S with a structure similar to that is shown in FIG. 2B, respectively.

The first input waveguide 311 may connect to the first optical input interface C, which may be formed on the receiving surface S and configured to receive the local light 173. To this end, the first optical input interface C may be configured to connect to the light path 230c. For example, the first optical input interface C may be an optical coupler to connect the light path 230c and the first input waveguide 311. The optical input interface C may also be a fusing point/interface, fusing the light path 230c and the first input waveguide 311 together. Accordingly, the local light 173 at the input port C may be expressed as:

$${E}_{L} = {P}_{L} exp \{ - j [ 2 π [ {f}_{c} ( nT + {t}_{s} ) + \frac{α {t}_{s}^{2}}{2} ] + {φ}_{0} + {φ}_{c} ] \} = {P}_{L} exp \{ - j [ {ω}_{L} t + {φ}_{L} ] \}$$

where φ_{c} may be the phase shift due to the optical length between point E and point C.

The second input waveguide 312 may connect to the second optical input interface C′, which may be formed on the receiving surface S and configured to receive the reflected signal light 174. For example, the second optical input interface C′ may be a light receiving aperture. The light receiving aperture C′ may be the terminal end of the second input optical waveguide 312 (e.g., an optical fiber), wherein the reflected signal light 174 may be directly incident into the second input optical waveguide 312. The light receiving aperture C′ may also be a micro-optical lens 410 connected to the second input optical waveguide 312, as shown in FIG. 2D. In this event, the reflected signal light 174 may be directly incident into the micro-optical lens, which may focus the reflected signal light 174 to the second input optical waveguide 312 (or the optical coupling unit). As described above, the reflected signal light 174 at the light receiving aperture C′ may be expressed as:

$${E}_{S} = {P}_{S} exp \{ - j [ 2 π [ {f}_{c} ( nT + {t}_{s} - τ ) + \frac{{α ( {t}_{s} - τ )}^{2}}{2} ] + {φ}_{0} ] \} = {P}_{S} exp \{ - j [ {ω}_{S} t + {φ}_{S} ] \}$$

The optical coupler 320 may be a 2×2 coupler formed on the receiving surface S and includes an input side and an output side. At the input side, the optical coupler 320 may connect to the first input optical waveguide 311 and the second input optical waveguide 312 to receive the local light 173 and the reflected signal light 174, respectively. At the output side, the optical coupler 320 may connect to the first output optical waveguide 331 and the second output optical waveguide 332. The optical coupler 320 may serve as a power beam splitter to split the local light 173 and send the split local light to the first output optical waveguide 331 and second output optical waveguide 332, respectivley. Similarly, the optical coupler 320 may split the reflected signal light 174 and send the split signal light to the first output optical waveguide 331 and the second output optical waveguide 332, respectively.

Further, the optical coupler 320 may be a 3 dB coupler, which splits two input lights into 50%:50% at its outputs. For a 3 dB optical coupler 320, it may receive the reflected signal light 174 and the local light 173, and serve as a power beam splitter. The reflected signal light 174 may be divided into two beams and each beam may be sent to one of the two output waveguides 331 and 332. The local light 173 may be divided into two beams and each beam may be sent to one of the two output waveguides 331 and 332. Then the light beams from the reflected signal light 174 and the light beams respectively interfere with each other in the output waveguides 331 and 332. The interfered light in the first output waveguide 331 may be the first interfered light 341, and the interfered light in the second output waveguide 332 may be the second interfered light 342. The interference in the optical coupler 320 may be expressed as:

$$[ \begin{matrix}{E}_{1} \\ {E}_{2}\end{matrix} ] = exp ( j Ψ ) [ \begin{matrix}1 & exp ( j \frac{π}{2} ) \\ exp ( j \frac{π}{2} ) & 1\end{matrix} ] [ \begin{matrix}{E}_{S} \\ {E}_{L}\end{matrix} ]$$

where E₁ is the first interfered light 341, E₂ is the second interfered light 342, and Ψ is the phase shift due to the optical coupler 320.

Next, the first interfered light 341 and the second interfered light may be converted into currents by a photo-electronic unit. As mentioned above, the photo-electronic unit may include the first photodetector 351, the second photodetector 352, the current combiner 360, and the output port 370. The first photodetector 351 and the second photodetector 352 may respectively connect to the current combiner 360 as two inputs. The output port 370 may also connect to the current combiner 360 as an output.

The first interfered light 341 may be outputted from the first optical output interface D and detected by (or be inputted to) the first photodetector 351 to generate a first current I₁; and the second interfered light 342 may be outputted from the second optical output interface D′ and detected by (or be input to) the second photodetector 352 to generate a second current I₂. For example, the first photodetector 351 and the second photodetector 352 may respectively be a photodiode. Alternatively, the first photodetector 351 and the second photodetector 352 may respectively be other types of photo-electronic sensors.

The first current I₁ and second current I₂ may then be inputted into the current combiner to generate an output current I₀, which may subsequently be outputted to the output port 370 as an electronic output signal. The current combiner may be any type of electronic device that can combine two or more current together. For example, the current combiner may be an amplifier 360 to generate an output current I₀. Filtering out the higher order terms, the output current I₀ may be expressed as:

I₀=A(I₁−I₂)=2AP cos[(ω_{S}−ω_{L})tₛ+φ_{S}−φₗ],

where A is the amplification of the amplifier, P is the overall power of current generated by the first current I₁ and second current I₂.

Substituting τ=2(R+vt)/c=2[R+v(nT+tₛ)]/c back to the output current I₀, and neglect higher order terms and relatively small terms, the output current I₀ may be further simplified as:

$${I}_{0} = 2 AP cos [ 2 π ( \frac{2 α R}{c} {t}_{S} + \frac{2 {f}_{c} v n}{c} T ) + \frac{4 π {f}_{c} R}{c} + {ϕ}_{c} ]$$

where the term

$$\frac{4 π {f}_{c} R}{c}$$

is a constant phase term, since R is an initial distance at which the target object is located.

The main frequency component of the frequency spectrum of the signal computed over one modulation period may be called beat frequency f_{b}, where

f_{b}=2αR/C

The derivation of the beat frequency may be based on the Fast Fourier Transform (FFT) algorithm which efficiently computes the Discrete Fourier Transform (DFT) of the digital sequence. Consequently, by applying the FFT algorithm over one signal period, the beat frequency and thus the range to the target:

R=f_{b}c/2α

On the other hand, there is also a phase

$$\frac{2 {f}_{c} v n}{c} T$$

associated with the beat frequency which changes linearly with the number of sweeps. The change of the phase indicates how the frequency of the signal changes over consequent number of periods. This change is based on the Doppler frequency shift which is the shift in frequency that appears as a result of the relative motion of two objects. The Doppler shift can be used to find the velocity of the moving object:

v=f_{d}c/2f_{c}

The Doppler shift of the signal can be found by looking at the frequency spectrum of the signal over n consecutive periods (n·T).

Additionally, there is another phase shift φ_{c} in the local light 173 due to the optical length between point E and point C. Because the optical length between point E and point C is specific to the photo-detecting unit c, it may be different from other photo-detecting units on the substrate 210, such as unit a, b, and d.

In order to provide every photo-detecting unit on the substrate 210 with a local light having the same phase, each of the at least one optical waveguide 230 may be configured to compensate the local light 173 with a phase difference with respect to a reference phase, where the reference phase may be pre-chosen. For example, when the photo-detecting unit c may be used to determine the reference phase, every other photo-detecting unit on the substrate 210 may be adjusted to receive their respective local light 173 with the same phase as the photo-detecting unit c.

To this end, the local light phase adjustment/compensation may be achieved by designing the waveguide 230 with the same optical length. For example, the photo-detecting units in the same line on the substrate 210 may be designed to connect to a waveguide 230 with the same physical length and same refractive index in its core layer. Phase of the local light 173 may also be adjusted/compensated by carefully adjusting the refractive index of the waveguide 230 for each of the photo-detecting unit. For example, because the length of waveguide 230a is longer than the length of the waveguide 230d, the refractive index of the core layer in the waveguide 230a may be adjusted to be lower than the refractive index of the core layer in the waveguide 230d, so that the actual optical length in the waveguide 230a is the same as the actual optical length in the waveguide 230d.

Additionally, the local light phase adjustment/compensation may also be achieved by forming, in the waveguide 230, a phase shifting unit 340 on the receiving surface S of the substrate 210 to individually shift the phase φ_{c} of the local light 173 when the local light 173 arrives at each photo-detecting unit 220.

In summary, the present application discloses an optical-electro system that may be implemented as a FMCW Flash Lidar. To solve the above-mentioned high noise and short detection range issues of traditional Lidars, the system in the present application uses FMCW technology to conduct the detection. Therefore, the present system is not susceptible to noise and may be used for long-range measurements. Additionally, because the system uses integrated circuits and/or optoelectronic technologies (e.g., Indium Phosphide, InGaAs etc.) to integrate pixel-scale photodetectors into a single chip, the system may collect distance and velocity information of target objects in the field of view through single laser shot. Further, the system in the present application is entirely solid state, which may integrate more laser units together than mechanical Lidars. Since data rate (e.g., data transmission speed) of a Lidar is related to the number of laser units and emission period of a single Lidar, the more laser units a single Lidar has, the shorter the emission period, and therefore the higher the data rate. Therefore, the system in the present application may have a data rate much higher than mechanical Lidars, and therefore can obtain 3-D images of its surroundings faster than a traditional TOF Lidar.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art that aspects of the present disclosure may be illustrated and described herein in any of a number of patentable classes or contexts, including any new and useful process, machine, manufacture, or composition of matter, or any new and useful improvement thereof. Accordingly, aspects of the present disclosure may be implemented by entirely hardware, entirely software (including firmware, resident software, micro-code, etc.), or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure, aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

What is claimed is:

1. An optical-electro system, comprising:
a substrate;
at least one photo-detecting unit at least partially formed on the substrate to detect a signal light;
at least one optical waveguide at least partially formed on the substrate, each of the at least one optical waveguide connected to one of the at least one photo-detecting unit to input a local light; and
at least one electronic output port connected to the at least one photo-detecting unit to transmit at least one electronic output signal from the at least one photo-detecting unit, wherein the at least one electronic output signal is associated with the signal light and the local light.

2. The optical-electro system of claim 1, wherein each of the at least one photo-detecting unit is manufactured through at least one of an optoelectronic technology or an integrated circuit technology.

3. The optical-electro system of claim 1, wherein each of the at least one photo-detecting unit includes at least one balanced photodetector.

4. The optical-electro system of claim 3, wherein the at least one balanced photodetector comprises:
a first optical input interface, formed on the substrate and connected to the optical waveguide to receive the local light from the optical waveguide;
a second optical input interface, formed on the substrate to receive the signal light;
an optical coupling unit formed on the substrate, connected to the first optical input interface and the second optical input interface, wherein the optical coupling unit couples the local light and the signal light to generate a first interfered light and a second interfered light;
a first optical output interface connected to the optical coupling unit to output the first interfered light; and
a second optical output interface connected to the optical coupling unit to output the second interfered light.

5. The optical-electro system of claim 4, wherein the at least one balanced photodetector further comprises:
a first photodetector to receive the first interfered light and convert the first interfered light into a first current;
a second photodetector to receive the second interfered light and convert the second interfered light to a second current; and
a current combiner, connected to:
the first photodetector to receive the first current,
the second photodetector to receive the second current,
one of the at least one electronic output port, and
wherein the current combiner combines the first current and the second current to form the at least one electronic output signal.

6. The optical-electro system of claim 5, wherein the current combiner comprises at least one amplifier.

7. The optical-electro system of claim 4, wherein the second optical input interface comprises at least one micro-optical lens to focus the signal light to the optical coupling unit.

8. The optical-electro system of claim 1, wherein the local light is coherent with the signal light.

9. The optical-electro system of claim 8, wherein local light comprises a modulated light wave.

10. The optical-electro system of claim 9, wherein the modulated light wave is a frequency modulated continuous wave.

11. The optical-electro system of claim 9, wherein the modulated light wave is at least one of an amplitude modulated continuous wave or a phase modulated continuous wave.

12. The optical-electro system of claim 1, wherein each of the at least one optical waveguide is configured to compensate the local light with a phase difference with respect to a reference phase.

13. The optical-electro system of claim 12, wherein the at least one optical waveguide comprises a phase shifting unit to compensate the local light with the phase difference with respect to the reference phase.

14. The optical-electro system of claim 12, wherein the at least one optical waveguide compensates the local light with the phase difference through optical path length compensation.

15. The optical-electro system of claim 12, wherein the at least one optical waveguide is configured to compensate the local light with the phase difference through refractive index compensation.

16. The optical-electro system of claim 1, further comprising:
a light source to emit a source light.

17. The optical-electro system of claim 16, further comprising a beam splitter to receive the source light and split the source light into an emitted signal light and the local light.

18. The optical-electro system of claim 17, wherein the signal light is the emitted signal light reflected from a target object.

19. The optical-electro system of claim 17, further comprising:
a light emission port to emit the emitted signal light.

20. The optical-electro system of claim 17, wherein the light emission port includes a diffuser to receive the emitted light beam and diffuse the emitted light beam towards a target object.
